(19) United States
(12) Patent Application Publication
(10) Pub. No.: US 2026/0080503 A1
(43) Pub. Date: Mar. 19, 2026

(54) METHOD AND DEVICE WITH IMAGE PROCESSING

(71) Applicant: SAMSUNG ELECTRONICS CO., LTD., Suwon-si (KR)

(72) Inventors: Geonseok SEO, Suwon-si (KR); Sanghyun SON, Suwon-si (KR); Sangwon LEE, Suwon-si (KR); Pilsu KIM, Suwon-si (KR); Jaehyoung YOO, Suwon-si (KR); Hyong Euk LEE, Suwon-si (KR)

(73) Assignee: SAMSUNG ELECTRONICS CO., LTD., Suwon-si (KR)

(21) Appl. No.: 19/225,142

(22) Filed: Jun. 2, 2025

(30) Foreign Application Priority Data
Sep. 13, 2024 (KR) 10-2024-0125937

(51) Int. Cl. G06T 3/4007; G06T 3/4046

(52) U.S. Cl. CPC G06T 3/4007; G06T 3/4046

(57) ABSTRACT

An image processing method including inputting an input image to a weight prediction model to predict a weight corresponding to each lookup table of a plurality of lookup tables, mapping a pixel value of the input image to a corresponding section of each lookup table of the plurality of lookup tables, calculating an adjusted pixel value corresponding to the corresponding section with respect to each lookup table of the plurality of lookup tables, and obtaining an output image with an adjusted resolution by performing a weighted sum of the adjusted pixel values according to the weight.

### CROSS-REFERENCE TO RELATED APPLICATIONS

This application claims the benefit under 35 USC § 119 (a) of Korean Patent Application No. 10-2024-0125937, filed on Sep. 13, 2024, in the Korean Intellectual Property Office, the entire disclosure of which is incorporated herein by reference for all purposes.

### BACKGROUND

### 1 Field

The following description relates to a method and device with image processing, and more particularly, to a machine vision decompanding module utilizing a network to learn optimal interpolation parameters per section.

### 2. Description of Related Art

Typical image processing was developed primarily for human visual needs. The main goal was to convert raw data obtained from the sensor into a form that is easy for humans to view, and image signal processing technology may be used for the goal. Image signal processing may process an image through color correction, denoising, gamma adjustment, and the like, but it may be difficult to produce a result that is optimized for machine recognition in special circumstances, such as low light or bad weather.

Typical image signal processing may use fixed parameters to improve human-perceived quality, but this approach may have limitations in delivering consistent performance in a variety of environments. Since machine vision recognizes images in different way than humans, it can be difficult for existing technologies to perform optimally in low light or adverse conditions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an image processing method including inputting an input image to a weight prediction model to predict a weight corresponding to each lookup table of a plurality of lookup tables, mapping a pixel value of the input image to a corresponding section of each lookup table of the plurality of lookup tables, calculating an adjusted pixel value corresponding to the corresponding section with respect to each lookup table of the plurality of lookup tables, and obtaining an output image with an adjusted resolution by performing a weighted sum of the adjusted pixel values according to the weight.

Each lookup table of the plurality of lookup tables may include a plurality of mapping points and each of the mapping points may be defined by a specific pixel value in a resolution range of the input image and a corresponding pixel value in a resolution range of the output image.

Rach of the mapping points may be set for each section of each lookup table of the plurality of lookup tables and used for performing interpolation.

The calculating of the adjusted pixel value may include obtaining a corresponding mapping point for the corresponding section and calculating the adjusted pixel value by performing interpolation to an output value corresponding to the pixel value of the input image in the corresponding section, based on the corresponding mapping point.

Each of the mapping points may include a value, the value being learned to adapt to respective illumination conditions of the input image and an environmental change of the input image.

The predicting of the weight may include predicting the weight corresponding to each lookup table of the plurality of lookup tables, according to contrast, noise, or texture of the input image.

The input image may include a plurality of color channels, the method may also include loading the plurality of lookup tables, and the plurality of lookup tables may be built in a learning phase.

The loading may include loading a plurality of independently trained lookup tables for each of the plurality of color channels.

The input image may include a plurality of channel images and the loading of the plurality of lookup tables may include loading a single three-dimensional (3D) lookup table including pixel values of the plurality of channel images as 3D coordinates.

The image processing method may include dividing the input image into a plurality of patches, and the calculating of the adjusted pixel value may include calculating the adjusted pixel value by applying different lookup tables and weight prediction models to each of the patches.

The predicting of the weight may include obtaining additional data corresponding to the input image and inputting the input image and the additional data to the weight prediction model and predicting the weight.

The input image may include a raw image obtained from an image sensor.

The input image may include an output image of an image processing module.

The obtaining of the output image may include obtaining an output image with an improved resolution by performing a weighted sum of the adjusted pixel values.

The image processing method may include inputting the output image to an image processing element and converting the output image and inputting the converted output image to a downstream processing element and obtaining a task result.

The downstream processing element may include a machine vision perception processing element.

The image processing element and the downstream processing element may be built based on an artificial neural network model and the weight prediction model, the image processing element, and the downstream processing element may be trained based on an end-to-end training method.

In a general aspect, here is provided an electronic device including processors configured to execute instructions and a memory storing the instructions, and an execution of the instructions configures the processors to input an input image to a weight prediction model to predict a weight corresponding to each lookup table of a plurality of lookup tables, map a pixel value of the input image to a corresponding section of each lookup table of the plurality of lookup tables, calculate an adjusted pixel value corresponding to the corresponding section with respect to each lookup table of the plurality of lookup tables, and obtain an output image with an adjusted resolution by performing a weighted sum of the adjusted pixel values according to the weight.

Each lookup table of the plurality of lookup tables may include a plurality of mapping points, each of the mapping points may be defined by a specific pixel value in a resolution range of the input image and a corresponding pixel value in a resolution range of the output image, and the processors may be further configured to obtain a corresponding mapping point for the corresponding section and calculate the adjusted pixel value by performing interpolation to an output value corresponding to a pixel value of the input image in the corresponding section, based on the corresponding mapping point.

The processors may be further configured to predict the weight corresponding to each lookup table of the plurality of lookup tables, according to contrast, noise, or texture of the input image.

### BRIEF DESCRIPTION OF THE DRAWINGS

FIG. 1 illustrates an example imaging system according to one or more embodiments.

FIG. 2 illustrates an example method of processing an input image in an imaging system according to one or more embodiments.

FIG. 3 illustrates an example configuration of an electronic device with resolution adjustment according to one or more embodiments.

FIGS. 4 and 5 illustrate examples of lookup tables according to one or more embodiments.

FIG. 6 illustrates an example method of processing an input image in an imaging system according to one or more embodiments.

FIG. 7 illustrates an example method of using a different resolution adjustment processing element for each color channel of an input image according to one or more embodiments.

FIG. 8 illustrates an example single three-dimensional (3D) lookup table corresponding to a plurality of color channels for an input image according to one or more embodiments.

FIG. 9 illustrates an example method of dividing an input image into a plurality of patches and applying a different resolution adjustment module to each patch according to one or more embodiments.

FIG. 10 illustrates an example effects of an image processing method according to one or more embodiments.

FIG. 11 illustrates an example electronic device according to one or more embodiments.

FIG. 12 illustrates an example image processing method according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The examples may be implemented as various types of products such as, for example, a personal computer (PC), a laptop computer, a tablet computer, a smartphone, a television (TV), a smart home appliance, an intelligent vehicle, a kiosk, a wearable device, and the like. Hereinafter, examples are described in detail with reference to the accompanying drawings. In the drawings, like reference numerals are used for like elements.

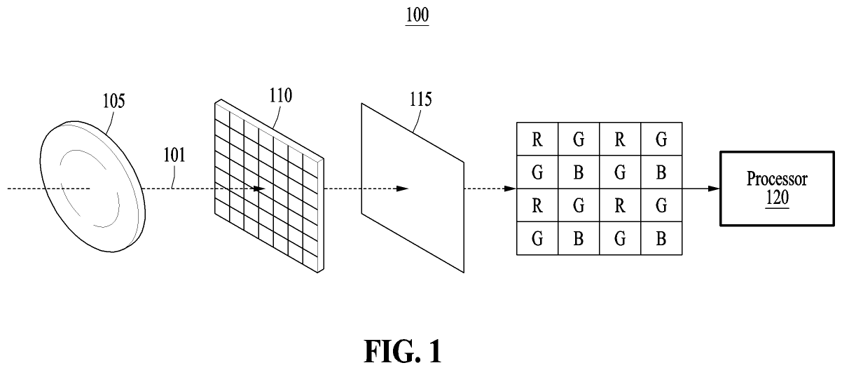

FIG. 1 illustrates an example imaging system according to one or more embodiments.

Referring to FIG. 1, in a non-limiting example, an imaging system 100 may be included as a portion of a mobile device, such as a smartphone, a tablet PC, a camera, or other devices. The imaging system 100 may include a lens 105, a color filter array (CFA) 110, an image sensor 115, and a processor 120. However, not all the illustrated components are essential components. In addition, the imaging system 100 may be implemented with more or fewer components than those shown. For example, the imaging system 100 may further include a controller, a memory, and a display.

One or more of the components of the imaging system 100 (e.g., one or more of the CFA 110, the image sensor 115, and the processor 120) may be instantiated as an element of a single integrated system, such as a system on a chip (SoC) or other integrated systems. In addition, the CFA 110 may be integrated with the image sensor 115. For example, pixels of the CFA 110 may be formed or disposed on a surface of the image sensor 115.

Light 101 may pass through the lens 105 and the CFA 110 and be detected by the image sensor 115, and the image sensor 115 may generate a CFA input image, using the received light 101. The lens 105 may include any suitable lens and may include, but not limited to, a rectilinear lens, a wide-angle (or “fisheye”) lens, a fixed focal length lens, a zoom lens, a fixed-aperture or variable-aperture lens, and the like. The image sensor 115 may include a complementary metal-oxide-semiconductor (CMOS) image sensor, a charge-coupled device (CCD) image sensor, or any other suitable image sensor.

The image sensor 115 may convert light into an electrical signal using a light-receiving element and may receive light by specifying an intensity of visible light of a specific wavelength through the CFA 110 to obtain color information as well as an intensity of the light. Through this, the intensity of the light of the wavelength at a corresponding position may be identified and color conversion perceived by humans may thus be performed.

In an example, the processor 120 may be one or more processors and may be included in an electronic device including one or more processors as described in greater detail below (e.g., electronic device 1100 and processor 1130). The processor 120 may include an image signal processor (ISP). The processor 120 may generate a red, green, and blue (RGB) image of the input signal sampled by the CFA 110. The CFA 110 may capture only one of the RGB colors for each pixel. In other words, a pixel may store color information of only one of red (R), green (G), or blue (B), but not of the other two. For example, a Bayer pattern may be arranged in a ratio of 50% green (G), 25% red (R), and 25% blue (B). The input signal sampled by the CFA 110 in this manner may be referred to as a raw image, raw data, a CFA input image, a CFA pattern, or a raw image of a CFA pattern. A raw image may not form a complete image since each pixel includes only one of the RGB colors.

In an example, an ISP may be implemented as a pipeline in which several hardware-or software-implemented modules are integrated. For example, an ISP may perform a variety of sequential operations, such as demosaicking, denoising, auto white-balance (AWB), and tone mapping. Demosaicking may refer to a process of interpolating partial color information obtained from the CFA 110 to produce a complete RGB pixel value. The ISP may estimate two missing colors of each pixel, using data of neighboring pixels. Through this process, the raw image may be converted to a complete RGB image with complete color information. An ISP pipeline may have different configurations and tuning parameters depending on the manufacturer.

The ISP may be used as an integral part of any product that uses a camera and may be applied to autonomous vehicle/pedestrian recognition, semiconductor inspection equipment, and a machine vision system. However, since most commercial ISPs have been developed primarily to mimic or adapt to a human visual system, tuning parameters thereof are set to look good to the human eye (i.e., from a human perspective), which may be different from settings that optimize performance from a perspective of a machine vision system. For example, tuning of ISPs for better recognition of a pedestrian or other vehicles from a machine vision perspective, such as in an autonomous driving situation, may differ, and it may be unlikely that conventional ISP tuning is optimized therefor. In particular, using conventional ISP tuning may lead to poor recognition performance in low light or bad weather conditions.

In general, a light intensity and a dynamic range in low light may be weaker and narrower than in normal light, so a lower resolution may cause difficulty in recognizing various objects in an image. In particular, since the human eye and a computer have different standards and ways of receiving an image signal, a conventional ISP module that adjusts a dynamic range based on the biological eye may not be suitable for a machine vision algorithm under various adverse conditions, including low light and inclement weather, as well as in a normal environment.

As described in greater detail below, an example image processing method relates to a resolution adjustment method that may be adaptively applied to an image environment and may play a key role in improving recognition performance in various environments, particularly from the machine vision perspective. However, the resolution adjustment method may be applied to a variety of examples as well as in machine vision ISP designs.

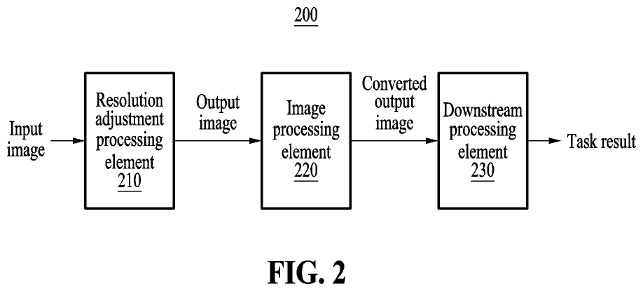

FIG. 2 illustrates an example method of processing an input image in an imaging system according to one or more embodiments. The description provided with reference to FIG. 1 may also apply to FIG. 2.

Referring to FIG. 2, in a non-limiting example, the imaging system 200 may include a resolution adjustment processing element 210, an image processing element 220, and a downstream processing element 230. In an example, the processing elements of the resolution adjustment processing element 210, the image processing element 220, and the downstream processing element 230 may be one or more processors of an electronic device (e.g., electronic device 1100 and processor 1130) and/or processor 120.

The image processing element 220 may include an ISP. The image processing element 220 may be used in a variety of image processing functions and may perform tasks such as color correction, gamma correction, denoising, and demosaicking. All functions of the image processing element 220 may be differentially modeled so that parameters of the ISP may be determined through learning. For example, the image processing element 220 and the downstream processing element 230 may be trained end-to-end together, or only the image processing element 220 may be trained as an objective function of the downstream processing element 230.

The downstream processing element 230 may be a module that performs downstream tasks based on an image processed by the image processing element 220. Downstream processing may refer to actually solving a specific issue, based on the image processed by the image processing element 220. In an autonomous vehicle, for example, the downstream processing element 230 may perform an autonomous driving task, such as detecting pedestrians or obstacles or analyzing road conditions, or an object recognition task, such as detecting specific objects (e.g., people, cars, animals, and the like), based on an image output from the image processing element 220.

Typically, an original raw image is used as is as an input to the ISP, and various processing modules in the ISP operate on the raw image. Through this, parameters of each module are learned, but a process of expanding a resolution of the input image is not included. A resolution may refer to an ability to more accurately and clearly represent details of the input image.

More specifically, a method using only a conventional ISP may have a difficulty in achieving optimal performance in downstream processing, that is, in specific tasks such as autonomous driving or machine vision. Typically, the input image is used as is and may thus have a number of limitations. The raw image obtained from a sensor may typically be generated by passing through a CFA consisting of red (R), green (G), and blue (B) channels, and the green (G) channel filter may be relatively more sensitive than the red (R) and blue (B) channels. For this reason, in a low-light environment, the green (G) channel may be doubled up to bring out fine details. However, since safety is a paramount concern in a machine vision-based recognition task such as autonomous driving, the red (R) channel may play a relatively more important role. For example, since most traffic signals and warning signs include red color, information in the red (R) channel may be more important for the safety of an autonomous vehicle. However, in the typical method, the CFA is predefined, and accordingly, a signal obtained therefrom may not provide color information optimized for downstream processing.

In addition, when the input image is typically converted from the raw image (e.g., a 16-bit resolution) to a compressed raw image (e.g., a 12-bit resolution), other issues may occur. A first issue is that an original resolution may be lost in a compression process. In a compressed state, details of the signal may be reduced, and a process for restoring the details of the signal may be needed. When reverting a compressed signal to an original state thereof, there is desire to recover as much lost information as possible, and this reversion may require a complex restoration process. A second issue is that the compressed raw image may be in a nonlinear domain. Since most ISPs are designed to operate in a linear domain, when a difference between the two domains are not addressed, inefficiencies may occur in a signal processing process. Thus, converting the input image into the linear domain may be an essential task, but the conventional ISP may not process the task properly, resulting in degraded quality of the image. Finally, since a dynamic range of light is narrower in a low-light environment than in a normal environment, it may be difficult for a machine to process the image when a resolution is reduced. The conventional ISP is primarily focused on adjusting the dynamic range to match the human visual system and may thus not be appropriate in a machine vision environment. For example, the dynamic range adjusted to the human eye may degrade object recognition performance for machine vision, and furthermore, may lead to misidentification of an object. Typical methods may do not explicitly consider the dynamic range and therefore fail to solve the performance degradation of an ISP in various adverse conditions, such as low light or inclement weather.

To solve these issues, the imaging system 200 may further include the resolution adjustment processing element 210 so that the image processing element 220 may process a higher-resolution input image. The resolution adjustment processing element 210 may perform various functions, including signal restoration and linear domain transformation, and may provide optimized color information required by a machine vision task. In particular, through an image with increased resolution, more accurate object recognition may be performed even in a low-light environment, and higher performance may be expected in a safety-critical task such as an autonomous driving system. The resolution adjustment processing element 210 may include a resolution expanding (i.e., decompanding) processing element and a resolution compressing (i.e., companding) processing element. Resolution compressing refers to an operation of reducing the resolution, in which a high dynamic range (HDR) image is converted to a low dynamic range (LDR) image. Resolution expanding refers to an operation of increasing the resolution, in which an LDR image is converted to an HDR image.

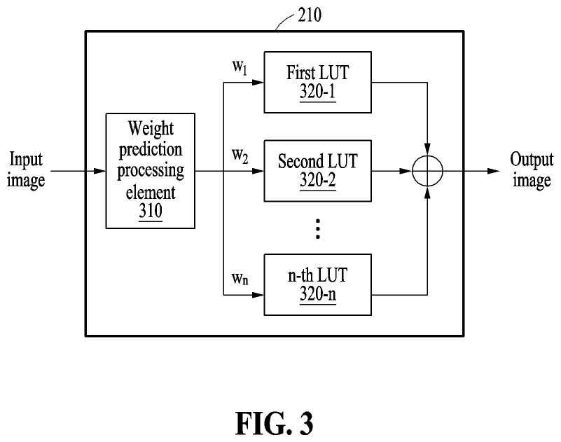

More specifically, the resolution adjustment processing element 210 may receive an input image (e.g., a raw image) and generate a resolution-adjusted output image (e.g., a raw image with expanded resolution). The image processing element 220 may receive the output image from the resolution adjustment processing element 210 and generate a converted output image (e.g., an RGB image), and the downstream processing element 230 may perform downstream processing (e.g., an autonomous driving task), based on the converted output image, to output a task result. Hereinafter, an operating method of the resolution adjustment processing element 210 is described in detail with reference to FIGS. 3 to 5.

FIG. 3 illustrates an example configuration of an electronic device with resolution adjustment according to one or more embodiments. The description provided with reference to FIGS. 1 and 2 may also apply to FIG. 3.

Referring to FIG. 3, in a non-limiting example, the resolution adjustment module 210 may include a weight prediction processing element 310 and a plurality of lookup tables (LUTs) 320-1 to 320-n, wherein n is a natural number greater than or equal to 2.

An input image may be transferred to the weight prediction processing element 310. The weight prediction processing element 310 may analyze characteristics of the input image and may predict weights w₁, w₂, . . . , wₙ for each of the LUTs 320-1, 320-2, . . . , 320-n, using a deep learning-based model. The weight prediction processing element 310 may have a variety of deep learning structures and may adaptively operate on a given input image to change a linear interpolation parameter for each section. For example, an image captured in a low-light environment may be given a different weight than an image captured in a high-light environment, and the weight may be dynamically determined through learning.

When the weights predicted by the weight prediction processing element 310 are transferred to each of the LUTs 320-1, 320-2, . . . , 320-n, the LUTs may perform a resolution expansion task on the input image. A number of the LUTs may be predetermined. Each of the LUTs 320-1, 320-2, . . . , 320-n may consist of parameters that expand a resolution to suit a predetermined section, and the parameters may be optimized during a learning process. This may indicate that each of the LUTs 320-1, 320-2, . . . , 320-n is designed to apply a most appropriate transformation for processing, with respect to a given dataset, a particular section of the image. For example, the first LUT 320-1 may be trained to perform appropriate transformation for a bright area, and the n-th LUT 320-n may be trained to provide a better result in a dark area. Each of the LUTs 320-1, 320-2, . . . , 320-n may consist of parameters that may perform optimal resolution expansion by reflecting characteristics of different sections.

Output values processed in each LUT may be weighted and summed according to the weights w₁, w₂, . . . , wₙ to generate a final output image. In other words, results obtained from each LUT may be summed in proportion to the weights, and in this process, the resolution may be adaptively adjusted according to the characteristics of the input image.

For example, it may be assumed a raw image captured in a low-light environment has been input. The weight prediction processing element 310 may predict the weights w₁, w₂, . . . , wₙ suitable for a low-light environment, through a deep learning model. Among the predicted weights, a higher weight may be assigned to the second LUT 320-n, which processes a dark area, than to the first LUT 320-1, which processes a light area. Through this, a dark portion may be more accurately restored in the final output image, and better performance may be expected than an existing method.

In the resolution adjustment processing element 210, the parameters composing each of the LUTs 320-1, 320-2, . . . , 320-n and the weights between each of the LUTs 320-1, 320-2, . . . , 320-n may be all optimized through learning, and optimal resolution expansion and a high-quality output image may thus be provided in a variety of imaging environments.

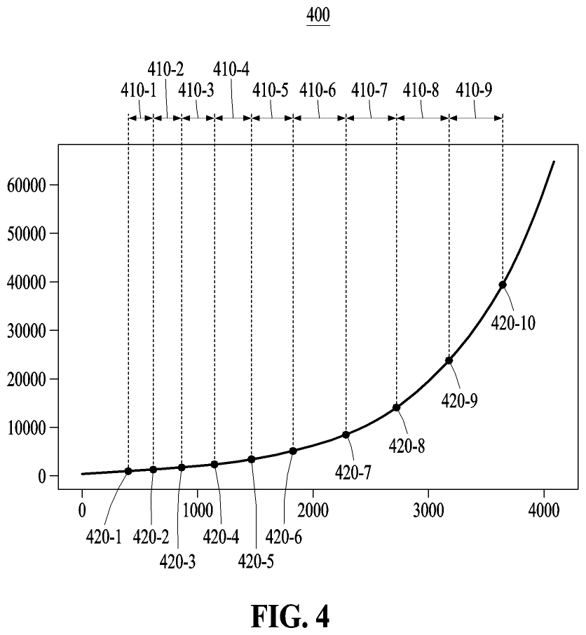

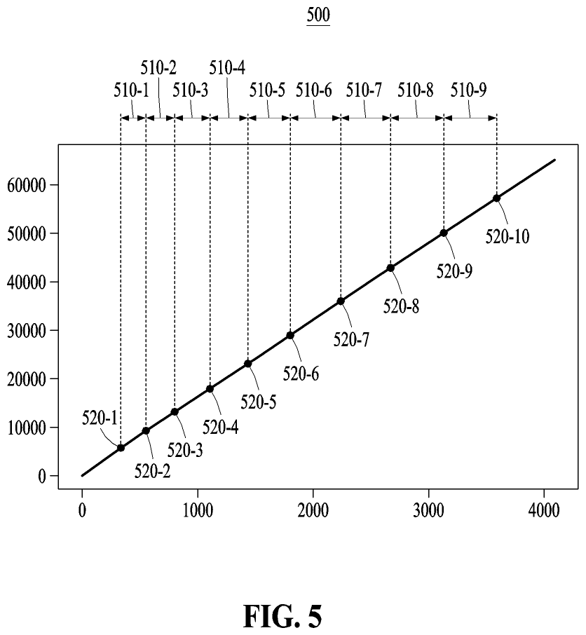

FIGS. 4 and 5 illustrate examples of lookup tables according to one or more embodiments. The description provided with reference to FIGS. 1 to 3 may also apply to FIGS. 4 and 5.

Referring to FIG. 4, in a non-limiting example, a first LUT 400 is a graph illustrating a non-linear LUT for expanding an input image with a 12-bit resolution to an image with a 16-bit resolution, the x-axis (an input value) may represent a pixel value (R(x, y)) of the input image, and the y-axis (an output value) may represent a pixel value (Rₒᵤₜ(x, y)), which corresponds to the input value, with an adjusted resolution. The LUT may consist of a plurality of mapping points, and each of the mapping points may be defined by a specific pixel value in the resolution range of the input image and a corresponding pixel value in the resolution range of the output image. In FIG. 4, the first LUT 400 is shown in a graph form, but this is for ease of description only, and the LUT may be expressed in various forms (e.g., a table) of structures that may represent pairs of coordinates of the mapping points.

The first LUT 400 may consist of a plurality of mapping points 420-1 to 420-10, and each of the mapping points 420-1 to 420-10 may be set to a value corresponding to one of sections 410-1 to 410-9. For example, the mapping points 420-1 and 420-2 may be set as corresponding values in the section 410-1, and the mapping points 420-2 and 420-3 may be set as corresponding values in the section 410-2. The mapping points may be determined through learning according to characteristics of the input image, and through this, the resolution of the input image may be expanded. In this case, a number of the mapping points (or a number of the corresponding segments) may be determined to be a fixed value. For example, when learning the mapping points of the first LUT 400, the first LUT 400 may be trained to determine ten mapping points.

In the case of an image that is input in a low-light environment, a non-linear transformation may be applied so that mapping points may be more finely arranged in an area with a small input value (e.g., a dark area) and accordingly, details in the dark area may be better expressed. In the above process, a size of each of the sections 410-1 to 410-9 and the corresponding mapping points may be optimized through learning, and through this, an output value in each section may be set. As shown in FIG. 4, a non-linear characteristic may be confirmed, in which as the input value decreases, a change of the output value decreases, and as the input value increases, the change of the output value gradually increases.

Referring to FIG. 5, in a non-limiting example, a second LUT 500 of FIG. 5 is a graph illustrating a linear LUT for expanding a resolution of an input image with a 12-bit resolution to an image with a 16-bit resolution. Similar to the first LUT 400 of FIG. 4, the x-axis (an input value) may represent a pixel value (R(x, y)) of the input image, and the y-axis (an output value) may represent a pixel value (Rₒᵤₜ(x, y)), which corresponds to the input value, with an adjusted resolution. The second LUT 500 may consist of a plurality of mapping points 520-1 to 520-10, and each of the mapping points 520-1 to 520-10 may be set to a value corresponding to one of sections 510-1 to 510-9. For example, the mapping points 520-1 and 520-2 may be set as corresponding values in the section 510-1 and the mapping points 520-2 and 520-3 may be set as corresponding values in the section 510-2.

When an LUT is determined by learning, the pixel value of the input image may be adjusted through interpolation. For example, the resolution adjustment processing element 210 that has completed learning may map the pixel value (R(x, y)) of the input image to a corresponding section. For example, when the pixel value (R(x, y)) of the input image is 1,000, the resolution adjustment processing element 210 may map the pixel value (R(x, y)) of the input image to the corresponding section 410-3.

Thereafter, the resolution adjustment processing element 210 may obtain a corresponding mapping point for the corresponding section and may calculate an adjusted pixel value by performing interpolation to an output value corresponding to the pixel value of the input image in the corresponding section, based on the corresponding mapping point. For example, the resolution adjustment processing element 210 may obtain the mapping points 420-2 and 420-3 corresponding to the corresponding section 410-3 and may calculate the adjusted pixel value by performing interpolation based on the mapping points 420-2 and 420-3. In the case of a mapping point (L₍ᵢ₋₁₎, Lᵢ) corresponding to an i-th corresponding section, the adjusted pixel value (R_{out_j(x,y)}) may be calculated according to Equation 1 below.

$${R}_{Out \_ i ( x , y )} = ( 1 - d ) * {L}_{i - 1} + d * {L}_{i} \qquad Equation 1$$

In Equation 1, d denotes a size of the i-th corresponding section, and R_{out_j(x,y)} denotes the adjusted pixel value in a j-th LUT. Similarly, the resolution adjustment processing element 210 may obtain the mapping points 520-2 and 520-3 corresponding to the corresponding section 510-3 and may calculate the adjusted pixel value by performing interpolation based on the mapping points 520-2 and 520-3. However, while a method of calculating the adjusted pixel value through linear interpolation is described in Equation 1, an interpolation method is not limited to the above example. For example, the adjusted pixel value may be calculated through various interpolation methods, such as though trilinear interpolation.

In an example, an output value (the adjusted pixel value) in each LUT may be weighted and summed according to the weights w₁, w₂, . . . , wₙ to generate a final output image. The above may be expressed as Equation 2 below.

$${R\_final}_{( x , y )} = {\sum }_{j = 1}^{K} {w}_{j} * R\_out {\_j}_{( x , y )} \qquad Equation 2$$

In Equation 2, R_{final}_{_{(x,y)}} denotes a pixel value of an output image for which the weighted sum has been completed, K denotes the number of LUTs, and wⱼ denotes a weight corresponding to the j-th LUT. In the above example, when the first LUT 400 is defined as a first LUT and the second LUT 500 is defined as a second LUT, the pixel value of the output image for which the weighted sum has been completed may be calculated as w₁*R_out_1_{(x,y)}+w₂*R_out_2_{(x,y)}.

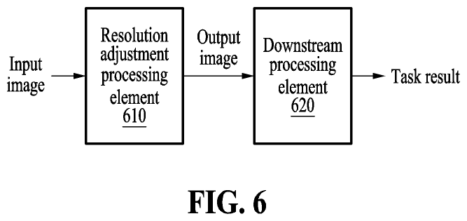

FIG. 6 illustrates an example method of processing an input image in an imaging system according to one or more embodiments. The description provided with reference to FIGS. 1 to 5 may also apply to FIG. 6.

Referring to FIG. 6, in a non-limiting example, a resolution adjustment processing element 610 may use various types of images as an input image, in addition to a raw image. For example, the resolution adjustment processing element 610 may obtain an output image of an image processing element as an input image. For example, the resolution adjustment processing element 610 may use an RGB image obtained through demosaicking in the image processing element as an input image. The resolution adjustment processing element 610 may generate an output image by increasing a resolution of the RGB image, and the output image may be input to a downstream processing element 620. The downstream processing element 620 may receive the output image and generate a task result.

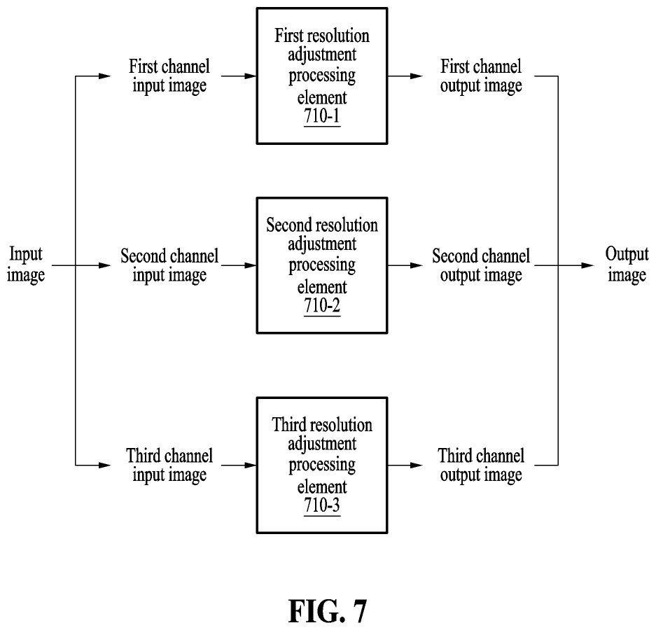

FIG. 7 illustrates an example method of using a different resolution adjustment processing element for each color channel of an input image according to one or more embodiments. The description provided with reference to FIGS. 1 to 6 may also apply to FIG. 7.

Referring to FIG. 7, in a non-limiting example, an input image may include a plurality of channel images, and one of independent resolution adjustment processing elements 710-1, 710-2, and 710-3 may be used for each channel.

For example, the input image may be an RGB image including a first channel (e.g., a red (R) channel) image, a second channel (e.g., a green (G) channel) image, and a third channel (e.g., a blue (B) channel) image. A first channel (red channel) input image may be processed by the first resolution adjustment processing element 710-1, through which a first channel output image may be generated. Similarly, a second channel (green channel) input image and a third channel (blue channel) input image may be independently processed via the second resolution adjustment processing element 710-2 and the third resolution adjustment processing element 710-3, respectively.

Since the resolution adjustment processing elements 710-1, 710-2, and 710-3 may be trained independently of each other, a number and a type of LUTs included in each of the resolution adjustment processing elements 710-1, 710-2, and 710-3 may be different from each other. For example, the first resolution adjustment module 710-1 that processes the first channel (e.g., the red (R) channel) image may use two LUTs, the second resolution adjustment module 710-2 that processes the second channel (e.g., the green (G) channel) image may use three LUTs, and the third resolution adjustment module 710-3 that processes the third channel (e.g., the blue (B) channel) image may use one LUT.

The reason for using different resolution adjustment modules for each channel is that different channels may require different image processing methods. For example, in autonomous driving or a machine vision system, the red channel may play an important role in detecting a critical element such as a traffic signal or a warning light, so higher resolution expansion and correction may be applied to the red channel. On the contrary, the green channel may react relatively more sensitively in a sensor and may thus be corrected in a different manner.

In this structure, optimized processing may be performed for each channel by applying a resolution adjustment processing element suitable for each channel, thereby improving the overall quality of the input image. Finally, output images of each channel may be combined to generate a final output image. Through this, image processing with higher accuracy and resolution may be performed.

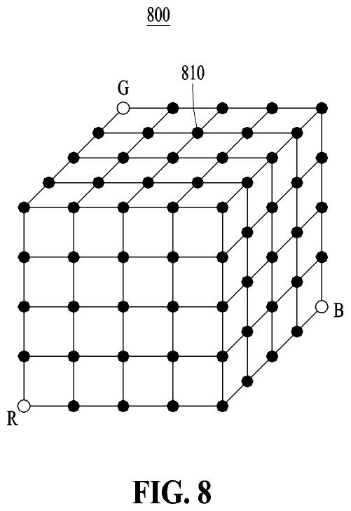

FIG. 8 illustrates an example single three-dimensional (3D) lookup table corresponding to a plurality of color channels for an input image according to one or more embodiments. The description provided with reference to FIGS. 1 to 6 may also apply to FIG. 8.

Referring to FIG. 8, in a non-limiting example, an input image may include a plurality of channel images, and a resolution may be adjusted using a single 3D LUT 800 corresponding to the plurality of color channels.

The single 3D LUT 800 may consist of input values corresponding to red (R), green (G), and blue (B) channels. A single 3D LUT 800 may include a plurality of mapping points. For example, a mapping point 810 may be a mapping point which corresponds to a specific RGB combination and through which an output value may be determined according to an input color value. In this example, the values of each channel may interact with each other to determine a final output value, and conversion of a complex color combination may be performed through the single 3D LUT 800.

In a process of using the 3D LUT 800, an additional process of interpolating the input color value to an appropriate mapping point to determine a final output may be needed. In FIG. 8, an interpolation operation may be performed in a piecewise trilinear interpolation manner. Trilinear interpolation is a method of calculating an output for an input value between eight adjacent mapping points in a 3D space. Specifically, the eight closest points in the 3D space in which the input value is located may be found, and linear interpolation may be performed between the points to calculate a final value. Through this, an optimal output value for input R, G, and B values may be determined.

The single 3D LUT method described with reference to FIG. 8 may perform more precise color adjustment by reflecting an interaction between the three R, G, and B channels, as opposed to the method described with reference to FIG. 7, which processes each channel independently. In particular, the single 3D LUT method described with reference to FIG. 8 may be capable of complex color variation processing and may be useful in applications that require precise color analysis, such as a machine vision system or autonomous driving.

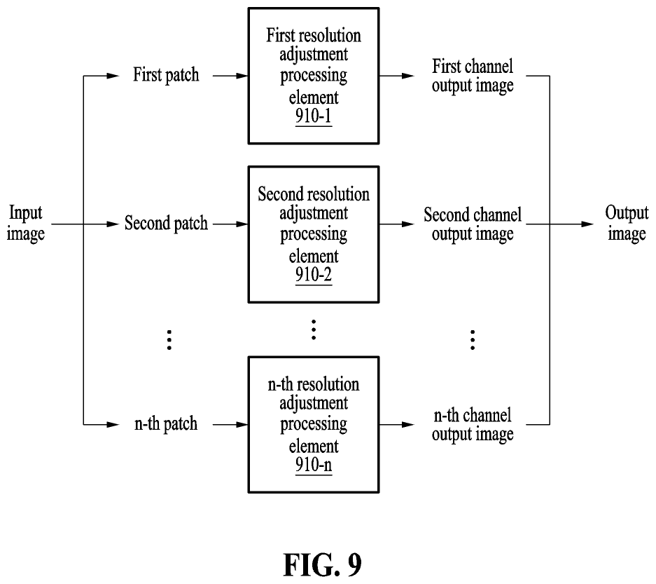

FIG. 9 illustrates an example method of dividing an input image into a plurality of patches and applying a different resolution adjustment module to each patch according to one or more embodiments h. The description provided with reference to FIGS. 1 to 8 may also apply to FIG. 9.

Referring to FIG. 9, in a non-limiting example, an input image may be divided into multiple patches based on determined criteria, and resolution adjustment may be performed independently for each patch.

The input image may be divided into a first patch, a second patch, . . . , an n-th patch. Each patch may be subject to separate image processing, and an output image may be generated for each patch through independent resolution adjustment modules 910-1, 910-2, . . . , 910-n. For example, an input image of the first patch may be processed by the first resolution adjustment module 910-1, and a first channel output image may be generated as a result of the processing. Similarly, an input image of the second patch may be processed by the second resolution adjustment module 910-2 to generate a second channel output image.

Here, the criteria for dividing patches may be determined by various metrics (or indicators). For example, a metric such as total variation may be used to divide patches based on various characteristics of an image, such as a change in illumination, texture, and the like. To the patches divided in this manner, an appropriate resolution adjustment module may be applied according to characteristics of each of the patches, and through this, the overall quality of the image may be improved.

This dividing and processing method may have an advantage of customized resolution adjustment according to local characteristics of the image. For example, high-resolution conversion, which is suitable for a bright area, may be needed in one patch, while finer processing customized to a dark area may be needed in another patch. The method described with respect to FIG. 9 may reflect the local characteristics and enable optimal resolution adjustment for each patch.

As a result, processing results for each patch may be combined into an output image, and through this, high-quality resolution expansion of the entire input image may be achieved. Through this method, more adaptive image processing may be performed, compared to a conventional method using a single module, and better performance may be expected, especially in a complex image environment. For example, in applications such as machine vision or autonomous driving, image recognition performance may be significantly improved through customized processing that considers the local characteristics of the image.

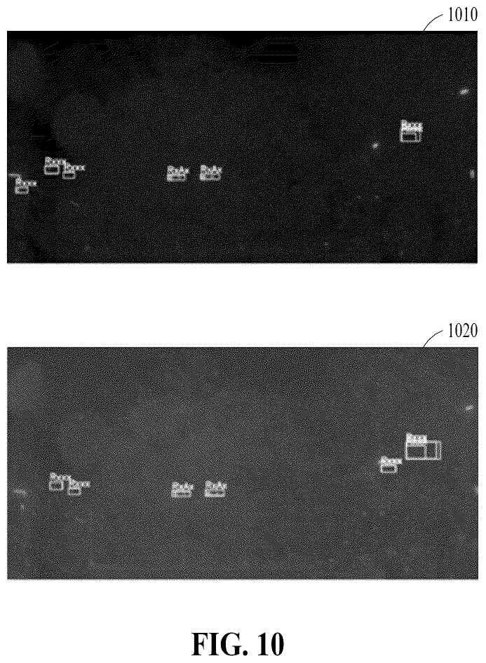

FIG. 10 illustrates an example effects of an image processing method according to one or more embodiments. The description provided with reference to FIGS. 1 to 9 may also apply to FIG. 10.

Referring to FIG. 10, in a non-limiting example, image 1010 illustrates a recognition result when an object recognition task is performed using a conventional ISP, and image 1020 illustrates a recognition result when an object recognition task is performed by applying a resolution adjustment module according to an example.

It may be confirmed that recognition performance is quantitatively and qualitatively improved by applying the image processing method according to an example, compared to when using the conventional ISP. A difference may be especially noticeable in a low-light image. In a low-light environment, a dynamic range is typically narrow and accordingly it is difficult to recognize an object, but by applying the image processing method, false positives have been significantly reduced and a saturation phenomenon has also been shown to be significantly reduced.

Specifically, a quantitative performance improvement was evaluated by a mean Average Precision (mAP) value, and performance improvement in a low-light environment was noticeable. The method using the resolution adjustment module according to an example showed a superior result in object detection performance compared to a conventional ISP method.

The qualitative result may also be confirmed in the drawing 1020, in which objects are recognized more clearly compared to the drawing 1010. In particular, when the resolution adjustment module was used instead of a gamma correction module of the conventional ISP, image quality and object recognition performance in a low-light environment were significantly improved. This may suggest that a process of expanding a resolution of an image is effective in processing a low-light image.

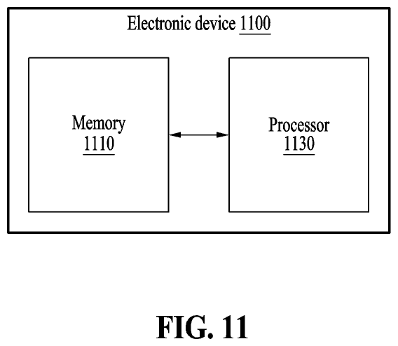

FIG. 11 illustrates an example electronic device according to one or more embodiments.

Referring to FIG. 11, in a non-limiting example, an electronic device 1100 may include a memory 1110 and a processor 1130. The memory 1110 may store instructions (or programs) executable by the processor 1130. For example, the instructions may include instructions for executing an operation of the processor 1130 and/or an operation of each component of the processor 1130. The processor 1130 may include one or more processors and may includes one or more processing elements.

The memory 1110 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The memory 1110 may include computer-readable instructions. The processor 1130 may be configured to execute computer-readable instructions, such as those stored in the memory 1110, and through execution of the computer-readable instructions, the processor 1130 is configured to perform one or more, or any combination, of the operations and/or methods described herein. The processor 1130 may be configured to execute programs or applications to configure the processor 1130 to control the electronic apparatus 1100 to perform one or more or all operations and/or methods involving image processing, and may include any one or a combination of two or more of, for example, a central processing unit (CPU), a graphic processing unit (GPU), a neural processing unit (NPU) and tensor processing units (TPUs), but is not limited to the above-described examples.

The data processing device implemented as hardware may include, for example, a microprocessor, a central processing unit (CPU), a processor core, a multi-core processor, a multiprocessor, an ASIC, and an FPGA.

The processor 1130 may perform the operation of the image processing method described with reference to FIGS. 1 to 9 in substantially the same manner. Accordingly, a detailed description thereof is omitted herein.

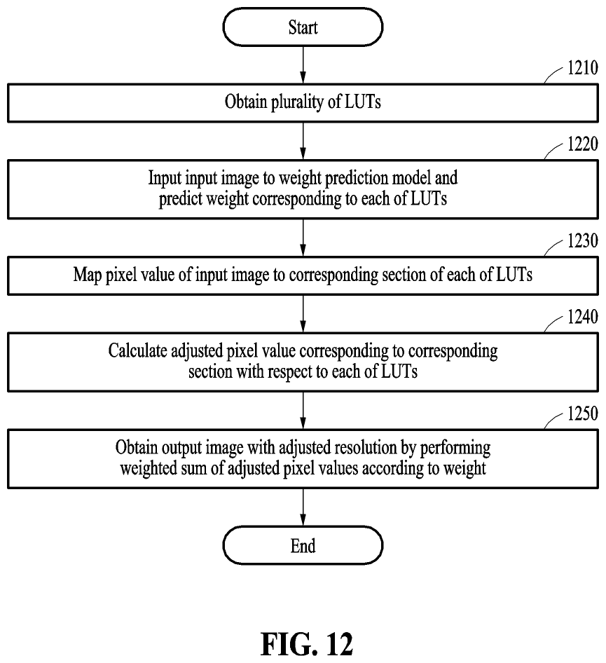

FIG. 12 illustrates an example image processing method according to one or more embodiments.

Furthermore, while the operations shown in FIG. 12 may be performed in the shown order and manner, the order of some operations may change, or some operations may be omitted without departing from the spirit and scope of the shown example. The operations shown in FIG. 12 may be performed in parallel or simultaneously.

Referring to FIG. 12, in a non-limiting example, in operation 1210, an electronic device (e.g., the electronic device 1100 of FIG. 11) may load a plurality of LUTs built in a learning phase.

In an example, in operation 1220, the electronic device (e.g., electronic device 1100) may input an input image to a weight prediction model and predict a weight corresponding to each of the LUTs. The electronic device may predict the weight corresponding to each of the LUTs, according to contrast, noise, or texture of the input image.

In an example, the electronic device may obtain additional data corresponding to the input image, input the input image and the additional data to the weight prediction model, and predict the weight. For example, in addition to the input image, the electronic device may input a gradient map, a standard deviation map, an edge component, and the like of the input image to the weight prediction model as the additional data. The weight prediction model may determine the weight of the LUTs by using the additional data together with the input image.

In an example, in operation 1230, the electronic device (e.g., electronic device 1100) may map a pixel value of the input image to a corresponding section of each of the LUTs. The input image may include a plurality of color channels. The electronic device may load a plurality of independently trained LUTs for each of the plurality of color channels. Alternatively, the electronic device may load a single 3D LUT that uses pixel values of a plurality of channel images as 3D coordinates.

The input image may be divided into a plurality of patches, and the electronic device may calculate an adjusted pixel value by applying different LUTs and weight prediction models to each of the patches.

In an example, in operation 1240, the electronic device (e.g., electronic device 1100) may calculate an adjusted pixel value corresponding to a corresponding section with respect to each of the LUTs.

In an example, the electronic device may obtain a corresponding mapping point for the corresponding section and may calculate an adjusted pixel value by performing interpolation to an output value corresponding to the pixel value of the input image in the corresponding section, based on the corresponding mapping point. Each of the LUTs may consist of a plurality of mapping points, and each of the mapping points may be defined by a specific pixel value in a resolution range of the input image and a corresponding pixel value in a resolution range of an output image. Each of the mapping points may be set for each section of each of the LUTs and may be used for performing interpolation. Each of the mapping points may include a value that has been learned to adapt to various illumination conditions and an environmental change of the input image.

In an example, in operation 1250, the electronic device (e.g., electronic device 1100) may obtain an output image with an adjusted resolution by performing a weighted sum of adjusted pixel values according to the weight.

The electronic devices, imaging systems, processors, processing elements, memories, neural networks, imaging system 100, CFA 110, image sensor 115, processor 120, imaging system 200, resolution adjustment processing element 210, image processing element 220, downstream processing element 230, weight prediction processing element 310, resolution adjustment processing element 610, downstream processing element 620, electronic device 1100, memory 1110, and processor 1130 described herein and disclosed herein described with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD−ROMs, CD−Rs, CD+Rs, CD−RWs, CD+RW, DVD−ROMs, DVD−Rs, DVD+Rs, DVD−RWs, DVD+RWs, DVD−RAMs, BD−ROMs, BD−Rs, BD−R LTHs, BD−REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An image processing method, the method comprising:
inputting an input image to a weight prediction model to predict a weight corresponding to each lookup table of a plurality of lookup tables;
mapping a pixel value of the input image to a corresponding section of each lookup table of the plurality of lookup tables;
calculating an adjusted pixel value corresponding to the corresponding section with respect to each lookup table of the plurality of lookup tables; and
obtaining an output image with an adjusted resolution by performing a weighted sum of the adjusted pixel values according to the weight.

2. The image processing method of claim 1, wherein each lookup table of the plurality of lookup tables comprises a plurality of mapping points, and
wherein each of the mapping points are defined by a specific pixel value in a resolution range of the input image and a corresponding pixel value in a resolution range of the output image.

3. The image processing method of claim 2, wherein each of the mapping points is set for each section of each lookup table of the plurality of lookup tables and used for performing interpolation.

4. The image processing method of claim 2, wherein the calculating of the adjusted pixel value comprises:
obtaining a corresponding mapping point for the corresponding section; and
calculating the adjusted pixel value by performing interpolation to an output value corresponding to the pixel value of the input image in the corresponding section, based on the corresponding mapping point.

5. The image processing method of claim 2, wherein each of the mapping points comprises:
a value, the value being learned to adapt to respective illumination conditions of the input image and an environmental change of the input image.

6. The image processing method of claim 1, wherein the predicting of the weight comprises:
predicting the weight corresponding to each lookup table of the plurality of lookup tables, according to contrast, noise, or texture of the input image.

7. The image processing method of claim 1, wherein the input image comprises a plurality of color channels, and
wherein the method further comprises:
loading the plurality of lookup tables, and
wherein the plurality of lookup tables are built in a learning phase.

8. The image processing method of claim 7, wherein the loading comprises:
loading a plurality of independently trained lookup tables for each of the plurality of color channels.

9. The image processing method of claim 7, wherein the input image comprises a plurality of channel images, and
wherein the loading of the plurality of lookup tables comprises:
loading a single three-dimensional (3D) lookup table including pixel values of the plurality of channel images as 3D coordinates.

10. The image processing method of claim 1, further comprising:
dividing the input image into a plurality of patches, and
wherein the calculating of the adjusted pixel value comprises:
calculating the adjusted pixel value by applying different lookup tables and weight prediction models to each of the patches.

11. The image processing method of claim 1, wherein the predicting of the weight comprises:
obtaining additional data corresponding to the input image; and
inputting the input image and the additional data to the weight prediction model and predicting the weight.

12. The image processing method of claim 1, wherein the input image comprises:
a raw image obtained from an image sensor.

13. The image processing method of claim 1, wherein the input image comprises:
an output image of an image processing module.

14. The image processing method of claim 1, wherein the obtaining of the output image comprises:
obtaining an output image with an improved resolution by performing a weighted sum of the adjusted pixel values.

15. The image processing method of claim 1, further comprising:
inputting the output image to an image processing element and converting the output image; and
inputting the converted output image to a downstream processing element and obtaining a task result.

16. The image processing method of claim 13, wherein the downstream processing element comprises:
a machine vision perception processing element.

17. The image processing method of claim 13, wherein the image processing element and the downstream processing element are built based on an artificial neural network model, and
wherein the weight prediction model, the image processing element, and the downstream processing element are trained based on an end-to-end training method.

18. An electronic device, comprising:
processors configured to execute instructions; and
a memory storing the instructions, wherein execution of the instructions configures the processors to:
input an input image to a weight prediction model to predict a weight corresponding to each lookup table of a plurality of lookup tables;
map a pixel value of the input image to a corresponding section of each lookup table of the plurality of lookup tables;
calculate an adjusted pixel value corresponding to the corresponding section with respect to each lookup table of the plurality of lookup tables; and
obtain an output image with an adjusted resolution by performing a weighted sum of the adjusted pixel values according to the weight.

19. The electronic device of claim 18, wherein each lookup table of the plurality of lookup tables comprises a plurality of mapping points,
wherein each of the mapping points are defined by a specific pixel value in a resolution range of the input image and a corresponding pixel value in a resolution range of the output image, and
wherein to the processors are further configured to:
obtain a corresponding mapping point for the corresponding section; and
calculate the adjusted pixel value by performing interpolation to an output value corresponding to a pixel value of the input image in the corresponding section, based on the corresponding mapping point.

20. The electronic device of claim 18, wherein the processors are further configured to:
predict the weight corresponding to each lookup table of the plurality of lookup tables, according to contrast, noise, or texture of the input image.
